(19) United States
(12) Patent Application Publication
(10) Pub. No.: US 2026/0063219 A1
(43) Pub. Date: Mar. 5, 2026

(54) PRESSURE REDUCTION SYSTEMS AND METHODS

(71) Applicant: Emerson Automation Solutions Final Control US LP, Houston, TX (US)

(72) Inventors: Li Chen Chen, Shanghai (CN); Cao Juanjuan, Shanghai (CN); Liang Hongkang, Shanghai (CN)

(21) Appl. No.: 19/302,450

(22) Filed: Aug. 18, 2025

(30) Foreign Application Priority Data
Aug. 29, 2024 (CN) 202411197449.1

(51) Int. Cl. F16K 31/363; F16K 17/02

(52) U.S. Cl. CPC F16K 31/363; F16K 17/02

(57) ABSTRACT

A pressure relief system can include a main valve, a pilot valve in communication with a sensing location that corresponds to a pressure of the main valve and controls operation of the main valve based on pressure at the sensing location, and a pressure reduction assembly arranged between the pilot valve and the sensing location including a reduction-assembly inlet that receives flow from the sensing location, an outlet that provides flow to the pilot valve, a first flow path extending between the inlet and the outlet, and a second flow path that diverges from the first flow path at a first end of the second flow path and directs fluid from the second flow path into the first flow path at a second end of the second flow path in a direction opposed to fluid flow in the first flow path.

### CROSS-REFERENCE TO RELATED APPLICATIONS

This application is based on and claims the benefit of priority from Chinese Patent Application No. 202411197449.1, filed on Aug. 29, 2024, which is hereby incorporated by reference in its entirety.

### BACKGROUND

Pilot-operated pressure relief valves can be used in a variety of industrial, commercial, and other settings to relieve pressure from a system during overpressure events. Unlike direct acting pressure relief valves, conventional pilot-operated pressure relief valves include a main valve for control of relief venting and a pilot valve to control operation of the main valve. The pilot valve can be configured to provide a particular set pressure threshold, so that if the pressure in the system being protected exceeds the set pressure, a dome-exhaust flow path in the pilot valve is opened to exhaust fluid from a dome of the main valve. This lowers the pressure in the dome, thereby allowing the main valve to open to vent excess pressure from the system line. Once the system line pressure reduces sufficiently below the set pressure, the dome-exhaust flow path can close and the pilot valve can, as appropriate, direct flow from the system line to re-pressurize (i.e., re-load) the dome.

### SUMMARY

According to one aspect of the present disclosure, a pressure relief system can include a main valve to control flow from an inlet of the main valve to an outlet of the main valve. A pilot valve can be in communication with a sensing location that corresponds to an inlet pressure of the main valve, the pilot valve being configured to control operation of the main valve based on pressure at the sensing location. A pressure reduction assembly can be arranged between the pilot valve and the sensing location, the pressure reduction assembly including a reduction-assembly inlet that receives flow from the sensing location, a reduction-assembly outlet that provides flow to the pilot valve, a first flow path extending between the reduction-assembly inlet and the reduction-assembly outlet, and a second flow path that diverges from the first flow path at a first end of the second flow path, and that directs fluid from the second flow path into the first flow path at a second end of the second flow path in a flow direction opposed to fluid flow in the first flow path, to generate turbulence within the first flow path.

In some examples, the pressure reduction assembly can include a Tesla valve.

In some examples, the pressure reduction assembly can include a housing and a spool within the housing that includes a first side defining a first flow channel that includes the first flow path and the second flow path, and a second side defining a second flow channel. The spool can be oriented within the housing to receive flow from the reduction-assembly inlet into the first flow channel, provide flow from the first flow channel to the second flow channel, and provide flow from the second flow channel to the reduction-assembly outlet.

In some examples, the second flow channel can define a different flow geometry than the first flow channel.

In some examples, the second flow channel can include a third flow path that receives fluid flow from the first flow channel, and a fourth flow path that diverges from the third flow path at a first end, and directs fluid from the fourth flow path into the third flow path at a second end in a direction opposed to fluid flow in the third flow path to generate turbulence within the third flow path.

In some examples, the first side of the spool can be an upstream side and the second side of the spool can be a downstream side, relative to flow through the housing. The spool can include an internal flow passage that extends between the first side and the second side to direct flow from the first flow channel to the second flow channel.

In some examples, the pressure reduction assembly can further include an inlet insert secured within an internal volume defined by the housing, and a spool cap arranged within the internal volume. The spool can be arranged within the internal volume between the inlet insert and the spool cap so that flow from the reduction-assembly inlet passes successively through the inlet insert, the spool, and the spool cap.

In some examples, a length of the first flow path between the first end of the second flow path and the second end of the second flow path can be less than about 90 percent of the length of the second flow path, inclusive, or the first and second flow path can collectively define a teardrop shape.

In some examples, the second flow path can be included in a plurality of second flow paths. The second flow paths of the plurality of second flow paths can be arranged successively along the first flow path to successively divert flow from the first flow path and return the diverted flow to the first flow path to generate turbulence.

According to another aspect of the present disclosure, a method of operating a pressure relief system can include receiving fluid from a sensing location that corresponds to an inlet pressure of a main valve. The method can include directing the fluid through a pressure reduction assembly arranged between the sensing location and a pilot valve, the pressure reduction assembly including a first flow path extending between an inlet and an outlet of the pressure reduction assembly, and a second flow path that diverges from the first flow path at a first end and rejoins the first flow path at a second end. The method can include generating turbulence within the first flow path by directing fluid from the second flow path into the first flow path in a flow direction opposed to fluid flow in the first flow path to reduce a magnitude of pressure spikes in the fluid at the sensing location. The method can include flowing the fluid with reduced pressure spikes from the reduction assembly to a pilot valve that controls operation of the main valve.

In some examples, the pressure reduction assembly can include a Tesla valve.

In some examples, the pressure reduction assembly can include a spool having a first side defining a first flow channel that includes the first flow path and the second flow path, and a second side defining a second flow channel with a different flow geometry than the first flow channel.

In some examples, the second flow channel can include a third flow path and a fourth flow path that diverges from the third flow path at a first end and rejoins the third flow path at a second end in a direction opposed to fluid flow in the third flow path to generate additional turbulence.

In some examples, a length of the first flow path between the first end of the second flow path and the second end of the second flow path can be less than about 90 percent of the length of the second flow path.

In some examples, the second flow path can be included in a plurality of second flow paths arranged successively along the first flow path to successively divert flow from the first flow path and return the diverted flow to the first flow path to generate turbulence.

According to yet another aspect of the present disclosure, a pressure reduction assembly for a pressure relief system can include a housing defining an internal volume, an inlet insert secured within the internal volume and defining an inlet opening, a spool cap arranged within the internal volume and defining an outlet opening, and a dual-sided spool positioned within the internal volume between the inlet insert and the spool cap. The dual-sided spool can include a first side defining a first flow channel with a first flow path and a second flow path that diverges from the first flow path at a first end of the second flow path, and that directs fluid from the second flow path into the first flow path at a second end of the second flow path in a flow direction opposed to fluid flow in the first flow path, to generate turbulence within the first flow path to reduce a magnitude of pressure spikes in fluid flowing from the inlet opening to the outlet opening. The dual-sided spool can include a second side defining a second flow channel in communication with the first flow channel.

In some examples, the second flow channel can include a third flow path and a fourth flow path that diverges from the third flow path at a first end and rejoins the third flow path at a second end in a direction opposed to fluid flow in the third flow path to generate additional turbulence.

In some examples, the dual-sided spool can include an internal flow passage that extends between the first side and the second side to direct flow from the first flow channel to the second flow channel.

In some examples, the second flow path can be included in a plurality of second flow paths arranged successively along the first flow path to successively divert flow from the first flow path and return the diverted flow to the first flow path to generate turbulence.

In some examples, the second flow channel may have a different flow geometry than the first flow channel.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a diagrammatic view of a flow system according to aspects of the present disclosure.

FIG. 2 is a side partial view of an example of a pressure relief system according to FIG. 1.

FIG. 3 is an axonometric view of an example pressure reduction assembly for use with the pressure relief system of FIG. 2.

FIG. 4 is a top plan view of a portion of the pressure reduction assembly of FIG. 3.

FIG. 5 is a side partial view of another example of a pressure relief system according to FIG. 1.

FIG. 6 is a cross-sectional view of an example pressure reduction assembly for use with the pressure relief system of FIG. 5.

FIG. 7 is a first-side axonometric view of an example spool for use with the pressure reduction assembly of FIG. 6.

FIG. 8 is a second-side axonometric view of the spool of FIG. 7.

FIG. 9 is a first-side plan view of the spool of FIG. 7.

FIG. 10 is a second-side plan view of the spool of FIG. 8.

FIG. 11 is a first-side axonometric view of another example spool for use with the pressure reduction assembly of FIG. 6.

FIG. 12 is a second-side axonometric view of the spool of FIG. 11.

FIG. 13 is a first-side plan view of the spool of FIG. 11.

FIG. 14 is a second-side plan view of the spool of FIG. 12.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Conventional pilot-operated relief valves can provide substantial benefits, such as those described above. But conventional designs also sometimes do not stay closed during operation of a corresponding system. For example, pressure fluctuations in a flow conduit (e.g., pipeline), vessel, or other equipment in communication with an inlet of a pilot-operated relief valve may result from transient pump operation (e.g., start-up) or other transient events. These fluctuations can result in cause undesirable effects, including undesired opening (e.g., rapid cycling) of a main valve of the pilot-operated relief valve, even when average system pressure has not exceeded a relevant set point. Correspondingly, this behavior of the main valve can cause unnecessary venting of service fluid or excessive wear on a main valve seat or other valve components.

In view of these issues, and others, it may therefore be useful to modify provide pressure relief systems that can mitigate the effect of temporary pressure spikes, while still allowing overall pressure monitoring and relief for the relevant system. For example, some embodiments can provide a pressure reduction assembly upstream of an inlet to a pilot valve of a pilot-operated relief valve, which may dampen or otherwise reduce the effect of pressure fluctuations on the pilot valve. For example, use of a pressure reduction assembly with various turbulence-inducing features can help to reduce the magnitude of transient pressure spikes while still generally allowing reliable communication of more steady-state pressure from a monitored system to a pilot valve. Accordingly, the pilot valve may tend to open a main valve of the pilot-operated relief valve in response to sustained pressure increases in the monitored system, but may tend not to open the main valve in response merely to transient pressure spikes that may not be indicative of overall system pressure increase.

Generally, a pressure reduction assembly according to this disclosure can define a first flow path for passage of fluid from a monitored system to a pilot valve, and a second flow path that diverts fluid from and then returns the diverted fluid to the first flow path. Accordingly, for example, a portion of the energy of a given fluid flow through the pressure reduction assembly can be diverted to generate turbulence (e.g., via reintroduction into the first flow path) and thus reduce the magnitude of transient pressure spikes. In some examples, a pressure reduction assembly may include a spool having a first side and a second side, with each side defining a flow channel configured to guide fluid through the spool. In such an arrangement, the flow channels may be designed in particular so that turbulence is generated within the fluid (e.g., as generally discussed above). Thus, under certain flow conditions (e.g., during high-frequency pressure spikes), the pressure of fluid at an outlet of the spool may be lower than the pressure of fluid at an inlet of the spool.

Generally, the pressure reduction assembly may be positioned between a pilot valve and a sensing location for inlet pressure at a main valve. For example, a pressure reduction assembly can be positioned upstream of an inlet of the pilot valve, and downstream of a sensing location within an inlet to the main valve (or a different sensing location for the monitored system pressure). Thus, as pressure fluctuates within the relevant system, the pressure reduction assembly may mitigate the effect of pressure spikes as sensed at the pilot valve inlet. Correspondingly, the pressure reduction assembly may reduce the risk of unnecessary venting of the main valve (e.g., by reducing the magnitude of a pressure spike that might otherwise momentarily exceeds a pilot valve set pressure and result in a corresponding venting of a dome and opening of the main valve).

In some examples, a pressure reduction assembly may include a Tesla valve (e.g., configured as a valvular conduit). In some examples, a pressure reduction assembly may include a valve spool having a series of islands (e.g., obstruction) that separate different flow paths along a flow channel. The islands may be configured guide the flow of fluid through a spool, for example, so that the fluid may be separated into respective flow paths with corresponding reduction in pressure. In some examples, the islands or flow paths may be designed so that the flow paths intersect to generate turbulence and thereby reduce the pressure of fluid at an outlet of the pressure reduction assembly.

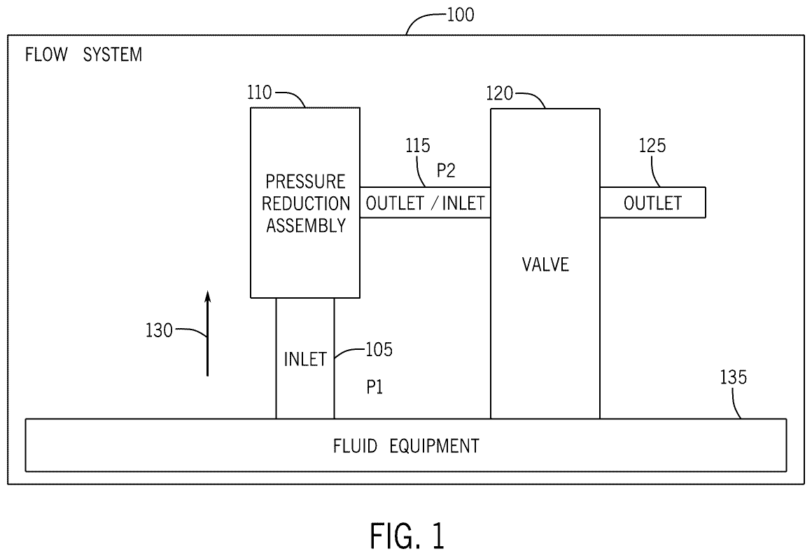

FIG. 1 shows an example of a flow system configured in particular as a pressure relief system 100. In some examples, the pressure relief system 100 may include fluid equipment 135 for transport, storage, or processing of a fluid (e.g., liquid or gas), which may be configured as a pipeline, various other monitored conduits, various types of containment or other vessels, or various other types of known equipment for fluid operations. In some examples, to permit the fluid within the equipment 135 to escape the equipment 135 (e.g., in the event of over-pressurization of the equipment 135), the equipment 135 may include a valve 120 (e.g., a pressure relief valve). The valve 120 may be configured to vent fluid from within the equipment 135 (e.g., to the atmosphere, a holding tank, etc.) when certain preconditions are met. For example, the valve 120 may be configured to vent fluid from within the equipment 135 when a pressure within the equipment 135 reaches a predetermined maximum value.

In some examples, to mitigate the risk of unnecessarily venting fluid, it may be advantageous to position a pressure reduction assembly 110 between the equipment 135 and the valve 120. The pressure reduction assembly 110 may generally serve as a spike snubber, being configured to damp fluctuations in fluid pressure (e.g., within the equipment 135) and correspondingly mitigate the risk of unnecessary release of fluid from the equipment 135 via the valve 120. For example, the pressure reduction assembly 110 may include a Tesla valve or other assemblies as discussed herein, which may generate turbulence in order to reduce a pressure (P2) at an outlet 115 of the pressure reduction assembly 110 relative to a pressure (P1) at a fluid inlet 105 of the pressure reduction assembly 110 (e.g., a system pressure of the fluid equipment 135).

In some examples, during a pressure surge within the equipment 135 (e.g., due to pump startup, etc.) fluid may flow into the pressure reduction assembly 110 via the inlet 105 and out of the pressure reduction assembly 110 via the outlet 115. However, after passing through the pressure reduction assembly 110, the pressure (P2) of the fluid may be reduced below the pressure of the equipment 135 (P1). Thus, the pressure (P2) passing from the outlet 115 into the valve 120 may be lower than the pressure (P1) passing from the equipment 135 into the pressure reduction assembly 110. As a result, the pressure reduction assembly 110 may reduce the effect of the pressure surge on the valve 120, which may reduce the risk of the valve 120 opening (e.g., venting fluid). In particular examples, including as further detailed below, the valve 120 can be a pilot-operated relief valve, with the reduced pressure P2 being passed to a pilot valve of the valve 120 to control dome pressure of a main valve of the valve 120.

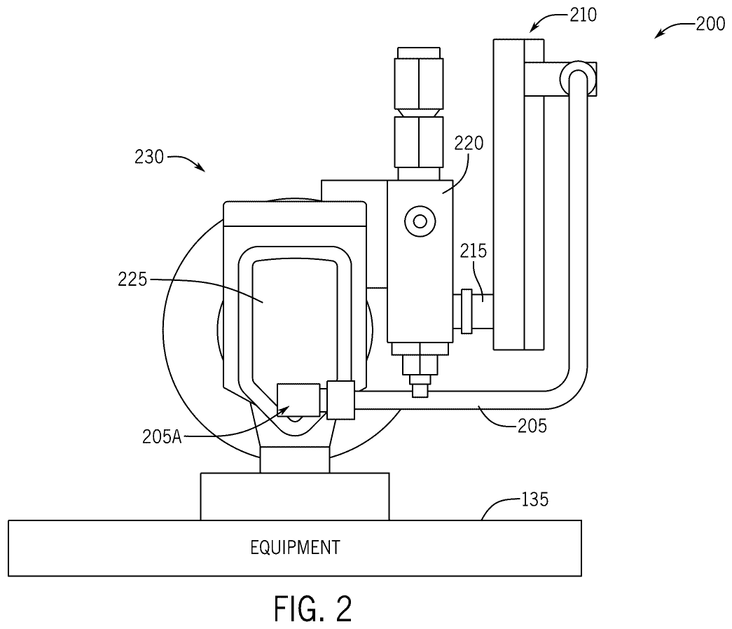

FIGS. 2-4 illustrate one example of a flow system configured as a pressure relief system 200 (e.g., as an example configuration of the schematically-illustrated arrangement of FIG. 1). In some examples, the pressure relief system 200 may include a pilot-operated relief valve 230, which may be configured to vent fluid from the equipment 135 when certain pressure conditions are met. In one example, the pilot-operated relief valve 230 may include a pilot valve 220 and a main valve 225. The pilot valve 220 may be connected to the main valve 225 and configured to selectively open/close the main valve 225 by control of pressure within a dome of the main valve 225. For example, the main valve 225 may open in order to vent fluid from the equipment 135 when fluid pressure in the equipment 135, as relayed to the pilot valve 220, exceeds a set pressure (e.g., corresponding to over-pressurization of the equipment 135).

In some examples, to mitigate the risk of inadvertently venting fluid from the pilot-operated relief valve 230, the pilot-operated relief valve 230 may include a pressure reduction assembly 210 arranged upstream of the pilot valve 220 (e.g., along an inlet line 205). In some examples, the pressure reduction assembly 210 may be arranged between the main valve 225 and the pilot valve 220. For example, as shown, the inlet line 205 connects to a sensing location 205A within an inlet of the main valve 225. Accordingly, pressure signals can be relayed from the inlet of the main valve 225 to the pilot valve 220 via the inlet line 205 and the pressure reduction assembly 210.

For some conditions, fluid from the equipment 135 may flow from the inlet 205 into the pressure reduction assembly 210, which may generate turbulence to reduce the pressure of the fluid (e.g., at an outlet 215). Thus, the fluid passing into the pilot valve 220 may be at a lower pressure than fluid passing into the pressure reduction assembly 210, and thus may be lower in pressure than the equipment 135 (e.g., and the inlet of the main valve 225). As a result, pressure fluctuations in the equipment 135 (e.g., due to pump startup, etc.) may be mitigated for (e.g., leveled out or otherwise reduced), without unnecessary venting of fluid from the relief valve 230.

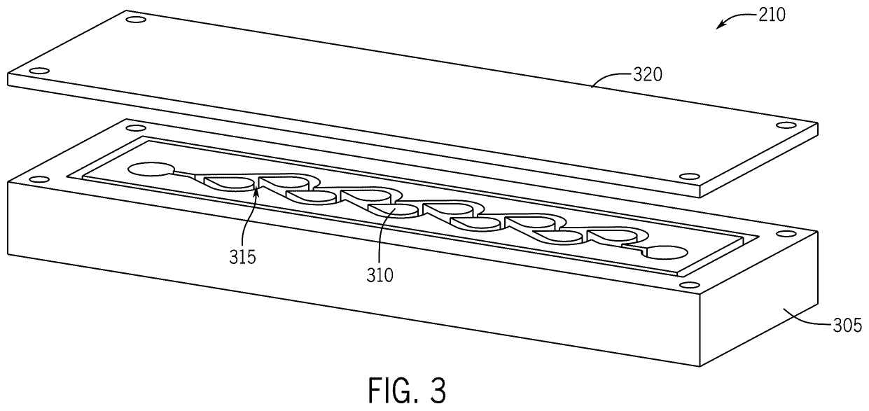

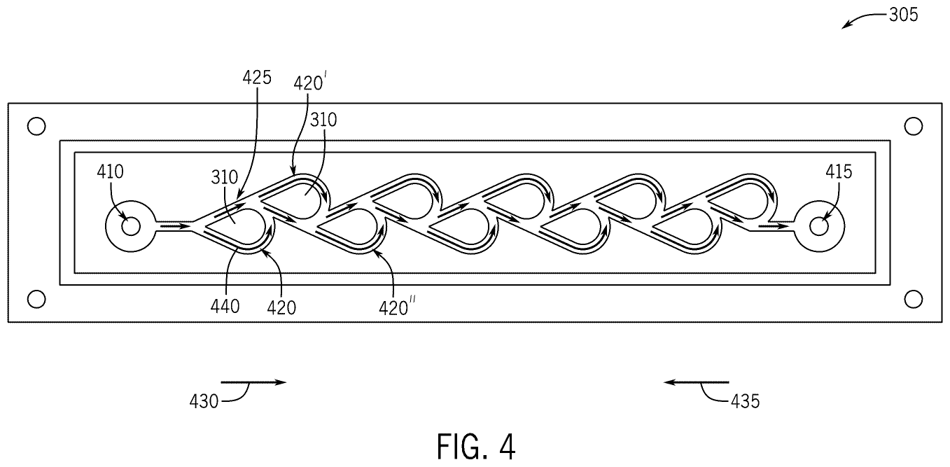

In different examples, a variety of flow geometries can be provided by a pressure reduction assembly, including with various generally known approaches for Tesla valves. With reference to FIGS. 3 and 4, in some examples, the pressure reduction assembly 210 may include a body 305 and a cover 320. The cover 320 may be secured to the body 305 (e.g., via one or more fasteners) in order to seal the pressure reduction assembly 210 against loss of fluid during pressurized operation. As shown in FIG. 4 in particular, the body 305 may define a flow channel 315 extending from an inlet 410 to an outlet 415 of the pressure reduction assembly 210. In some examples, the flow channel 315 may be shaped via one or more islands 310, which may be configured to break-up the flow of fluid through the pressure reduction assembly 210 to allow separation and remixing of flow streams and corresponding reduction of fluid pressure.

In some examples, the islands 310 may define multiple fluidically parallel flow paths for fluid. For example, the islands may form an obstacle that separates fluid flow into a first flow path 425 and a second flow path 420. Generally, the second flow path 420 may divert a portion of fluid from the first flow path 425, then introduce the diverted fluid back into the first flow path 425 (e.g., at a downstream location). Correspondingly, in some examples, relative to intersection points between the flow paths 420, 425 (e.g., as defined by ends of the second flow path 420), the second flow path 420 may define a longer distance of travel for fluid (e.g., shown by arrow 440) as compared to the first flow path 425 (e.g., shown by arrows 445). Relatedly, a direction with which the second flow path 420 introduces fluid back into the first flow path 425 may generally be opposed (e.g., perpendicular or at least partly opposite) to a local direction of flow along the first flow path 425.

Thus, as fluid from the equipment 135 passes through the pressure reduction assembly 210 (e.g., generally in the direction shown by arrow 430) turbulence may be generated. For example, the fluid moving via the second flow path 420 may consistently interfere with fluid moving via the first flow path 425. As a result, the pressure of the fluid may be lowered. Thus, sudden pressure fluctuations at the equipment 135 may be damped, which may mitigate the risk of unnecessary venting of fluid with the corresponding relief valve.

In some examples, if fluid were to pass through the pressure reduction assembly 210 in the direction shown by arrow 435, the fluid may pass through the pressure reduction assembly 210 without generating the same degree of turbulence as when flowing in the direction of arrow 430. Thus, the pressure reduction assembly 210 may be said to be unidirectional, with fluid moving in the direction shown by arrow 430 generating turbulence and lowering the pressure of the fluid, and with fluid moving in the direction shown by arrow 435 passing through the pressure reduction assembly 210 without generating turbulence.

In some examples, multiple sets of second flow paths can be arranged successively along one or more first flow paths, to successively divert fluid from and then reintroduce fluid into the first flow path(s). For example, as shown in FIG. 4, a plurality of second flow paths 420, 420′, 420″, etc. can be arranged successively along the first flow path 425, each extending fluidically in parallel with the first flow path 425 between respective ends of the second flow paths 420, 420′, 420″ that intersect the first flow path 425. As such, during flow through the pressure reduction assembly 210 in the direction shown by the arrow 430, the second flow paths 420, 420′, 420″, etc. can successively divert fluid from the first flow path 425 and then reintroduce the diverted fluid into the first flow path 425 at a downstream location to generate turbulence and corresponding reduction in pressure.

As also generally noted above, in some examples, a pressure reduction assembly 210 may be in the form of a Tesla valve. In other examples, the pressure reduction assembly 210 may include any arrangement of components that reduces transient pressure spikes while permitting reliable steady-state communication of pressure. Correspondingly, the pressure reduction assembly 210 may include a wide arrangement of components or structures that define enlargements, recesses, projections, baffles, buckets, or other geometry that can generate appropriate resistance to flow of fluid from a monitored system to a pilot valve. Similarly, the pressure reduction assembly 210 may variously include a wide arrangement of components that define one or more flow channels with intersecting flow channels (e.g., of different lengths) to generate turbulence and corresponding pressure reduction.

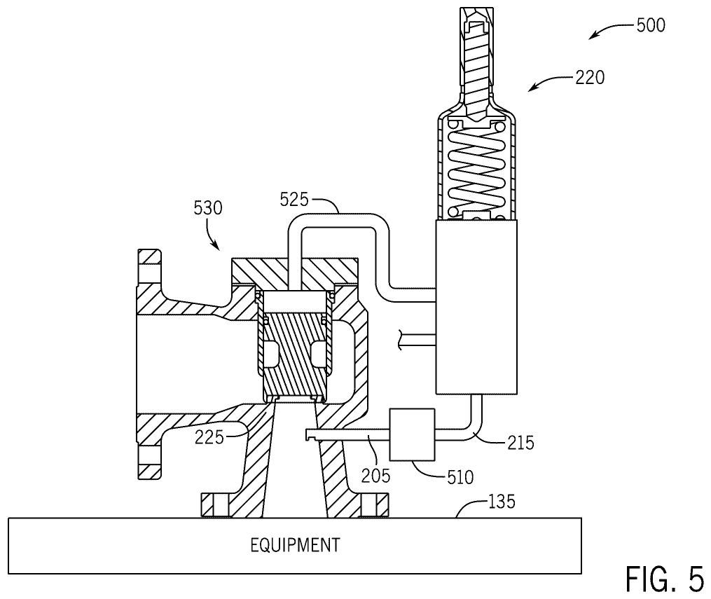

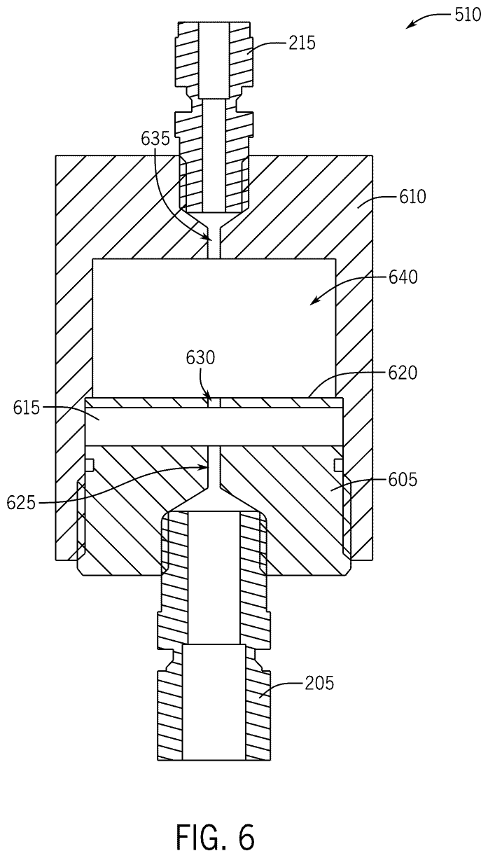

FIGS. 5 and 6 illustrate another example of a flow system configured as a pressure relief system 500 (e.g., as an example configuration of the schematically-illustrated arrangement of FIG. 1). As will be recognized, the pressure relief system 500 shares a number of components in common with and operates in a similar fashion to the examples illustrated and described previously (e.g., the pressure relief system 200). For the sake of brevity, these common features will not be again described below in detail. Rather, previous discussion of similarly named or numbered features, unless otherwise indicated, also applies to example configurations of the pressure relief system 500.

In some examples, as shown in FIG. 5, the pressure relief system 500 may include a pilot-operated relief valve 530 having a pressure reduction assembly 510 arranged upstream of the pilot valve 220—and, in particular, between an inlet to the pilot valve 220 and a sensing location 205A for the pilot valve within an inlet of the main valve 225. As generally discussed above, this arrangement can help to mitigate the effect on the pilot valve 220 of pressure fluctuations in the equipment 135. In some examples, the pressure reduction assembly 510 may reduce (e.g., damp) pressure fluctuations from the equipment 135 so that a pressure at the outlet 215 of the pressure reduction assembly 510 is lower than a pressure in the inlet 205 of the pressure reduction assembly 510.

In some examples, as shown in FIG. 6, a pressure reduction the pressure reduction assembly 510 may include a housing 610 and a cap formed as an inlet insert 605 together forming an interior volume 640. In some examples, the inlet insert 605 may be secured to the housing 610 (e.g., with a threaded, press-fit, or snap-fit engagement), with the housing 610 circumferentially surrounding the inlet insert 605. Further, the inlet insert 605 may be secured to the inlet 205, while the housing 610 may be secured to the outlet 215. Moreover, a spool 615 can be secured within the housing 610 (e.g., between the inlet insert 605 and a cap 620). Thus, fluid flow through the inlet 205 may be forced through the inlet insert 605 (e.g., via an opening 625), through a spool 615, and out of the housing 610 (e.g., via an opening 635) before passing into the outlet 215. However, other constructions for a housing and various inlet/outlet structures are also possible.

Generally, the spool 615 may be configured to reduce the pressure of fluid flowing through. For examples, the spool 615 may include flow channels that divert and combine various flow paths to generate turbulence, which may reduce a pressure of the fluid. In some examples, the spool 615 may define a series of flow channels and obstructions designed to cause fluid flow within the spool to meet (e.g., meet with opposed directions) in order to generate turbulence. IN this regard, for example, the spool 615 may be in the form of a Tesla valve, with one or more islands, bends, etc. designed to generate turbulence within the spool 615.

In some examples, the spool 615 may be positioned over the opening 625 of the inlet insert 605 so that fluid flows from the opening 625 into the spool 615. Once fluid flows into the spool 615, the pressure of the fluid may be reduced (e.g., via the flow paths, obstacles, etc. generating turbulence). Following this, the fluid may travel out of the spool 615 and through an opening 630 defined by the spool cap 620. In some examples, the fluid may then fill the interior volume 640 defined by the housing 610 before flowing out of the opening 635 and into the outlet 215. As mentioned previously, the pressure of the fluid at the outlet 215 may be lower than the pressure of the fluid at the inlet 205.

In some examples, the pressure reduction assembly 510 may include one or more gaskets, O-rings, seals, etc. in order to mitigate the risk of fluid leakage from the pressure reduction assembly 510. Further, while the spool cap 620 is currently shown with only a single opening 630, a spool cap 620 may include one or more openings depending on the intended use case or associated flow system.

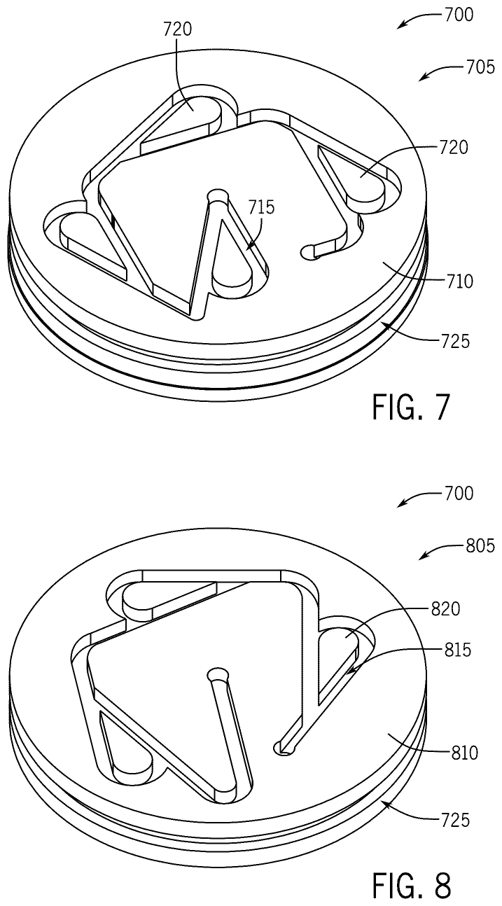

FIGS. 7 and 8 show examples of a spool 700 for use with the pressure reduction assembly 510 described previously (e.g., as an example implementation of the spool 615). In some examples, the spool 700 may be dual-sided, with a first side 705 of the spool 700 including a first flow channel 715 and a second side 805 of the spool 700 having a second flow channel 815 with different flow geometry.

To reduce fluid pressure during operation, the first flow channel 715 may define various intersecting flow paths, including as may operate similarly to the first and second flow paths as discussed above. In some examples, as shown in FIG. 7, the first flow channel 715—and the associated flow paths—may be defined by one or more islands 720 and corresponding grooves formed on (e.g., into) a surface 710 on the first side 705 of the spool 700. In some examples, the islands 720 may define a teardrop shape, with one end forming an angle of about 30 degrees and another end forming a rounded shape.

Correspondingly, as shown in FIG. 8, the second side 805 of the spool 700 may include the second flow channel 815. Again, to reduce flow pressure during operation, the second flow channel 815 may also define various intersecting flow paths, including as may operate similarly to the first and second flow paths as discussed above. In particular, the second flow channel 815—and the associated flow paths—may be defined by one or more islands 820 and corresponding grooves formed on (e.g., into) a surface 810 on the second side 805 of the spool 700. In some examples, the islands 820 may define a similar shape to the islands 720 described previously. However, in other examples, the islands 820 may define different shapes than the islands 720.

In some examples, the spool 700 include a circumferential groove 725 around a circumference of the spool 700 (e.g., between the first and second sides of the spool). In some examples, the groove 725 may be configured to receive one or more gaskets, O-rings, seals, etc. in order to mitigate the risk of fluid leaking past the spool 700 rather than passing through the flow channels 715, 815. Further, while the spool 700 is shown with a circular cross-section, the spool 700 may be any shape as desired by a user (e.g., to conform to a shape of the opening formed by the housing 610).

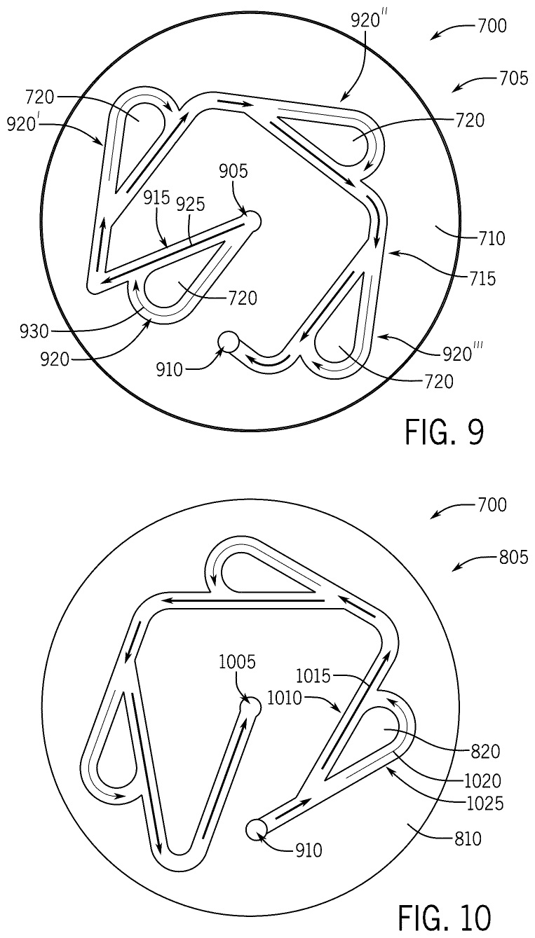

An example arrangement of the flow channel 715 on the first side 705 of the spool is further detailed in FIG. 9. In use, fluid may pass through, the opening 625 in the inlet insert 605 and enter the first side 705 of the spool 700 at an inlet point 905. Following this, the fluid may begin to flow along the flow channel 715 until contacting the island 720 (e.g., the first island nearest to the inlet point 905). Contact with the island 720 may then cause the fluid to diverge between a first flow path 915 (e.g., shown by arrow 925) and a second flow path 920 (e.g., shown by arrow 930). As similarly discussed above, the diverted flow along the second flow path 920 can then be introduced back into the first flow path 915, to generate turbulence and associated pressure reduction. In some examples, the first flow path 915 may be shorter in length than the second flow path 920 (e.g., may be less than about 90 percent, or about 70 percent to about 90 percent of the length of the second flow path 920). Further, the first flow path 915 may be generally straight, without bends or obstructions. In some examples, the second flow path 920 may be J-shaped, with a straight portion and a curved portion.

In some examples, the curved portion of the second flow path 920 may direct the fluid within the second flow path 920 towards the fluid in the first flow path 915. Thus, as can be seen by arrows 925, 930, the fluid in the second flow path 920 may meet fluid in the first flow path 915 with an opposed (e.g., perpendicular, or partly opposite) flow, which may generate particularly high levels of turbulence within the flow channel 715.

In some examples, the flow channel 715 may include a series of successive second flow paths 920 (e.g., defined by a series of islands 720). Thus, as the fluid passes through the flow channel 715 (e.g., from the inlet point 905 to an outlet point 910), the fluid may repeatedly generate turbulence at successive locations along the flow channel 715, which may reduce the pressure (e.g., due to sudden pressure fluctuations) of the fluid. In particular, the illustrated example includes four second flow paths 920, 920′, 920″, 920″′ that diverge from and then rejoin a common first flow path 915. In other example, however, different numbers or orientations of first or second flow paths are possible.

In some examples, the outlet point 910 of the first side 705 of the spool 700 may serve as an inlet point for the second side 805 of the spool 700. Put differently, the outlet point 910 may be in the form of (or connect to) a through-opening extending through the spool 700. Thus, as shown in FIG. 10, fluid may flow into the flow channel 815 on the second side 805 of the spool via the through-opening (i.e., from the outlet point 910, as shown in FIG. 9). Following this, the fluid may begin to flow along the flow channel 815 until contacting the island 820. After contacting the island 820, the fluid may diverge between a third flow path 1010 (e.g., shown by arrow 1015) and a fourth flow path 1025 (e.g., shown by arrow 1020). In some examples, the third flow path 1010 may be shorter in length than the fourth flow path 1025 (e.g., may be less than about 90 percent, or about 70 percent to about 90 percent of the length of the fourth flow path 1025). Further, the third flow path 1010 may be generally straight, without bends or obstructions. In some examples, the fourth flow path 1025 may be J-shaped, with a straight portion and a curved portion. In some examples, as similarly discussed above, multiple fourth flow paths can be provided in some cases, to divert fluid from and then rejoin the diverted fluid to one or more third flow paths.

In some examples, the curved portion of the fourth flow path 1025 may direct the fluid within the fourth flow path 1025 back towards the fluid in the third flow path 1010. Thus, as can be seen by arrows 1015, 1020, the fluid in the third flow path 1010 and the fourth flow path 1025 may meet at an intersection of the flow paths 1010, 1025 with opposed flow directions, which may generate turbulence within the flow channel 815. As mentioned previously, the turbulence generated within the spool 700 may correspondingly reduce a pressure of fluid that passes into the pilot valve 220. Thus, in the event of rapid pressure fluctuations in the equipment 135 (e.g., due to pump startup, etc.) the spool may damp the pressure fluctuations, which may mitigate the risk of the pilot-operated relief valve unnecessarily venting fluid.

In some examples, the islands 720, 820 and the flow channels 715, 815 on both the first side 705 and the second side 805 of the spool 700 may have similar (e.g., identical) geometry. However, in other examples, the islands, flow channels, or flow paths may differ between the first side and the second side of the spool.

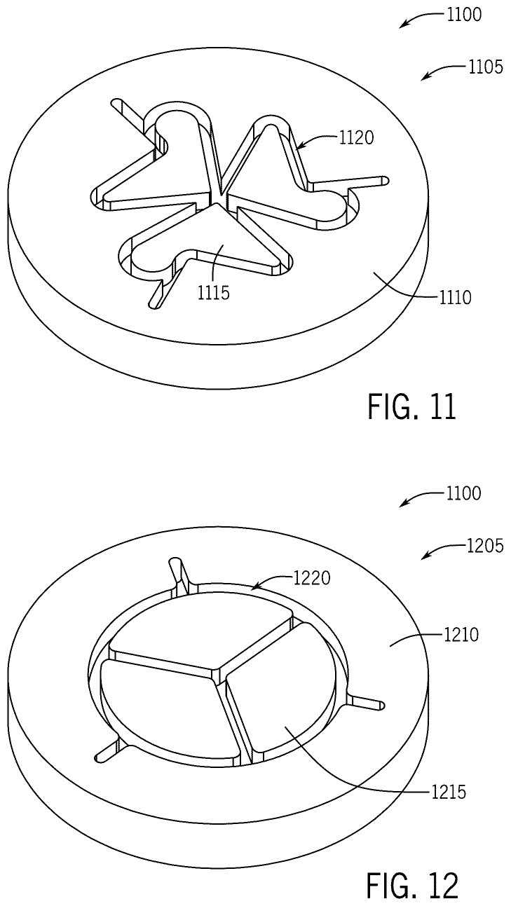

FIGS. 11-14 illustrate another example of a spool 1100 (e.g., as an example implementation of the spool 615, for use with the pressure reduction assembly 510). As will be recognized, the spool 1100 shares a number of components in common with and operates in a similar fashion to the examples illustrated and described previously (e.g., the spool 700). For the sake of brevity, these common features will not be again described below in detail. Rather, previous discussion of similarly named or numbered features, unless otherwise indicated, also applies to example configurations of the spool 1100.

In some examples, the spool 1100 may be dual-sided, with a first side 1105 of the spool 1100 including a first flow channel 1120 (see FIG. 11) and a second side 1205 of the spool 1100 having a second, different flow channel 1220 (see FIG. 12).

In some examples, as shown in FIG. 11, the first flow channel 1120—and the associated flow paths—may be defined by one or more islands 1115 and corresponding grooves formed on (e.g., into) a surface 1110 on the first side 1105 of the spool 1100. Correspondingly, as shown in FIG. 12, the second side 1205 of the spool 1100 may include the second flow channel 1220. The second flow channel 1220—and the associated flow paths—may be defined by one or more islands 1215 and corresponding grooves formed on (e.g., into) a surface 1210 on the second side 1205 of the spool 1100. In some examples, the islands 1215 may define different shapes than the islands 1115. Thus, the flow channels 1120, 1220 may be different.

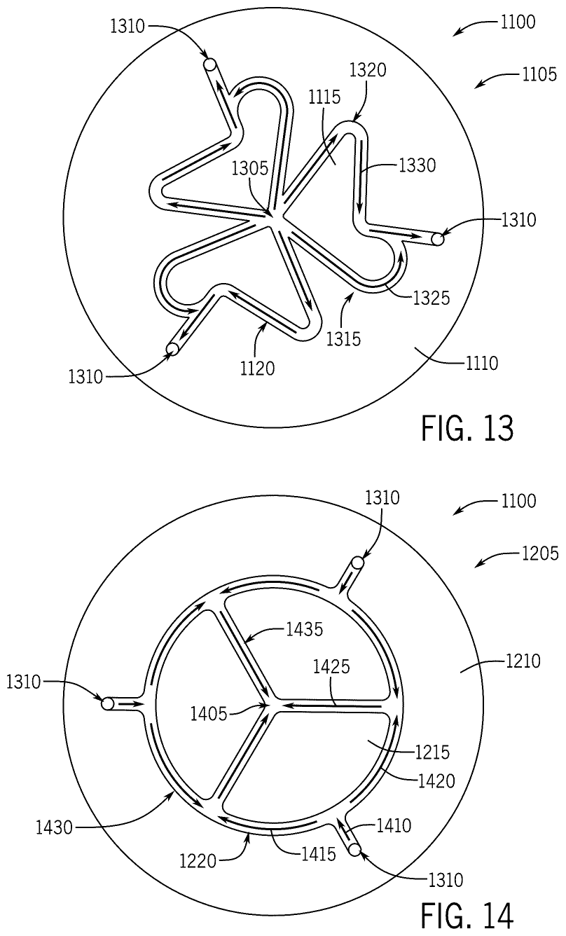

With respect to FIG. 13, an example arrangement of the flow channel 1120 on the first side 1105 of the spool 1100 is shown. In use, fluid may pass through the opening 625 in the inlet insert 605 and enter the first side 1105 of the spool 1100 at an inlet point 1305. Following this, the fluid may begin to disperse along the flow channel 715 until contacting one of the one or more of the islands 1115. In one particular example, the inlet point 1305 may be arranged in about a center of the spool 1100, with the islands 1115 arranged around the inlet point 1305. For example, three of the islands 1115 (or another number of islands) can be arranged around the inlet point 1305. Thus, the islands 1115 may direct the fluid along one or more first flow paths 1320 (e.g., shown by arrows 1330) and one or more second flow paths 1315 (e.g., shown by arrows 1325).

Generally, as also described above, the second flow path(s) 1315 may divert fluid from and then rejoin the diverted fluid to flow along the first flow path(s) 1320. In some examples, the one or more first flow paths 1320 may be equal to or longer in length than the corresponding second flow path(s) 1315. For example, the one or more first flow paths 1320 may be equal to or longer in length than the corresponding second flow paths 1315 to mitigate the risk of a pressure wave (e.g., from the fluid) escaping through the spool. In some examples, for a particular set of flow paths, the second flow path 1315 may be J-shaped, with a straight portion and a curved portion, whereas the first flow path 1320 may define a zig-zagged shape with one or more bends along the length of the flow path 1320. In some particular examples, the second flow path 1315 may define a length that is less than about 90 percent or between about 70 and about 90 percent, inclusive, of the length of the first flow path 1320. In another example, the second flow path 1315 may define a length that is about 85 percent the length of the first flow path 1320. In one example, the second flow path 1315 may define a length of about 0.9811 inches, while the first flow path 1320 may define a length of about 1.15 inches. As mentioned above, in some examples, the second flow path 1315 may define a length that is equal to the length of the first flow path 1320.

In some examples, first and second flow paths 1315, 1320 may be designed to direct the fluid within the flow paths towards each other (e.g., as shown by arrows 1325, 1330). Thus, the fluid in the first flow path 1315 and the second flow path 1320 may meet in opposed directions, which may generate turbulence within the flow channel 1120.

As mentioned above, in some examples, the flow channel 1120 may be defined by three islands 1115 spaced circumferentially around the inlet point 1305. The islands 1115 may define three separate first flow paths 1315 and three separate second flow paths 1320, which may each guide fluid from the inlet point 1305 to a respective outlet point 1310. Put differently, each of the islands, first flow paths, and second flow paths, may direct fluid from a single inlet point to one or more outlet points (e.g., three outlet points). In other examples, however, other numbers of configurations of flow paths are possible.

In some examples, the outlet points 1310 of the first side 1105 of the spool 1100 may serve as inlet points for the second side 1205 of the spool 1100. Put differently, the outlet points 1310 may be in the form of, or connect to, through-openings extending through the spool 1100. Thus, as shown in FIG. 14, fluid may flow into the flow channel 1220 on the second side 1205 of the spool via the through-openings (and from the various outlet points 1310). Following this, the fluid may begin to flow along the flow channel 1220 (e.g., away from the through-openings as shown by arrows 1410) until contacting the islands 1215. As mentioned previously, in some cases, the second side 1205 of the spool 1100 may include three islands 1215 arranged circumferentially around the spool 1100, although other configurations are possible.

After contacting the islands 1215, due to the arcuate shape of the side of the island 1215, the fluid may diverge to flow in opposing directions of a third flow path 1430 (e.g., as shown by arrows 1415, 1420). In some examples, the third flow path 1430 may define a ring shape, circumferentially surrounding the islands 1215. Further, as fluid passes along the third flow path 1430, the fluid traveling in the direction shown by arrow 1415, and fluid traveling in the direction shown by arrow 1420 may meet (e.g., head-on), which may generate turbulence.

In some examples, after flow from the various outlet points 1310 intersects, the fluid may further travel down one or more fourth flow paths 1435 (e.g., shown by arrows 1425). The fourth flow paths 1435 may each extend from the third flow path 1430 towards an outlet point 1405 of the second side 1205 of the spool 1100. In some examples, each of the fourth flow paths 1435 may meet at the outlet point 1405, which may further generate turbulence in the fluid. Thus, as mentioned previously, the turbulence generated within the spool 1100 may correspondingly reduce a pressure of fluid that passes into the pilot valve 220. Thus, in the event of rapid pressure fluctuations in the equipment 135 (e.g., due to pump startup, etc.) the spool may damp the pressure fluctuations, which may mitigate the risk of the pilot-operated relief valve unnecessarily venting fluid.

In some examples, the above-described pressure reduction assemblies may be used in a variety of flow systems. For example, the flow systems may include liquid, fluid, gas, air, water, or any other known flow systems. In other examples, the flow systems may include equipment for transport, storage, or processing of a fluid (e.g., liquid, gas, water, air, natural gas, etc.). Further, in some examples, the flow systems may be configured as a pipeline, various other monitored conduits, various types of containment or other vessels, or various other types of known equipment for fluid operations. Correspondingly, the pressure reduction assemblies (e.g., as described above) may be useful for reducing pressure within the various flow systems. In some examples, the pressure reduction assemblies may further be useful for snubbing, buffering, mitigating water hammer, or other functions within the flow systems.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A pressure relief system, comprising:
a main valve to control flow from an inlet of the main valve to an outlet of the main valve;
a pilot valve in communication with a sensing location that corresponds to an inlet pressure of the main valve, the pilot valve being configured to control operation of the main valve based on pressure at the sensing location; and
a pressure reduction assembly arranged between the pilot valve and the sensing location, the pressure reduction assembly including:
a reduction-assembly inlet that receives flow from the sensing location;
a reduction-assembly outlet that provides flow to the pilot valve;
a first flow path extending between the reduction-assembly inlet and the reduction-assembly outlet; and
a second flow path that diverges from the first flow path at a first end of the second flow path, and that directs fluid from the second flow path into the first flow path at a second end of the second flow path in a flow direction opposed to fluid flow in the first flow path, to generate turbulence within the first flow path.

2. The pressure relief system of claim 1, wherein the pressure reduction assembly includes a Tesla valve.

3. The pressure relief system of claim 1, wherein the pressure reduction assembly includes:
a housing; and
a spool within the housing that includes:
a first side defining a first flow channel that includes the first flow path and the second flow path; and
a second side defining a second flow channel;
the spool being oriented within the housing to receive flow from the reduction-assembly inlet into the first flow channel, provide flow from the first flow channel to the second flow channel, and provide flow from the second flow channel to the reduction-assembly outlet.

4. The pressure relief system of claim 3, wherein the second flow channel defines a different flow geometry than the first flow channel.

5. The pressure relief system of claim 3, wherein the second flow channel includes:
a third flow path that receives fluid flow from the first flow channel; and
a fourth flow path that diverges from the third flow path at a first end, and directs fluid from the fourth flow path into the third flow path at a second end in a direction opposed to fluid flow in the third flow path to generate turbulence within the third flow path.

6. The pressure relief system of claim 3, wherein the first side of the spool is an upstream side and the second side of the spool is a downstream side, relative to flow through the housing; and
wherein the spool includes an internal flow passage that extends between the first side and the second side to direct flow from the first flow channel to the second flow channel.

7. The pressure relief system of claim 3, wherein the pressure reduction assembly further includes:
an inlet insert secured within an internal volume defined by the housing; and
a spool cap arranged within the internal volume;
wherein the spool is arranged within the internal volume between the inlet insert and the spool cap so that flow from the reduction-assembly inlet passes successively through the inlet insert, the spool, and the spool cap.

8. The pressure relief system of claim 1, wherein one or more of:
a length of the first flow path between the first end of the second flow path and the second end of the second flow path is less than about 90 percent of the length of the second flow path, inclusive; or
the first and second flow path collectively define a teardrop shape.

9. The pressure relief system of claim 1, wherein the second flow path is included in a plurality of second flow paths; and
wherein the second flow paths of the plurality of second flow paths are arranged successively along the first flow path to successively divert flow from the first flow path and return the diverted flow to the first flow path to generate turbulence.

10. A method of operating a pressure relief system, comprising:
receiving fluid from a sensing location that corresponds to an inlet pressure of a main valve;
directing the fluid through a pressure reduction assembly arranged between the sensing location and a pilot valve, the pressure reduction assembly including:
a first flow path extending between an inlet and an outlet of the pressure reduction assembly; and
a second flow path that diverges from the first flow path at a first end and rejoins the first flow path at a second end;
generating turbulence within the first flow path by directing fluid from the second flow path into the first flow path in a flow direction opposed to fluid flow in the first flow path to reduce a magnitude of pressure spikes in the fluid at the sensing location; and
flowing the fluid with reduced pressure spikes from the reduction assembly to a pilot valve that controls operation of the main valve.

11. The method of claim 10, wherein the pressure reduction assembly includes a Tesla valve.

12. The method of claim 10, wherein the pressure reduction assembly includes a spool having a first side defining a first flow channel that includes the first flow path and the second flow path, and a second side defining a second flow channel with a different flow geometry than the first flow channel.

13. The method of claim 12, wherein the second flow channel includes a third flow path and a fourth flow path that diverges from the third flow path at a first end and rejoins the third flow path at a second end in a direction opposed to fluid flow in the third flow path to generate additional turbulence.

14. The method of claim 10, wherein a length of the first flow path between the first end of the second flow path and the second end of the second flow path is less than about 90 percent of the length of the second flow path.

15. The method of claim 10, wherein the second flow path is included in a plurality of second flow paths arranged successively along the first flow path to successively divert flow from the first flow path and return the diverted flow to the first flow path to generate turbulence.

16. A pressure reduction assembly for a pressure relief system, comprising:
a housing defining an internal volume;
an inlet insert secured within the internal volume and defining an inlet opening;
a spool cap arranged within the internal volume and defining an outlet opening; and
a dual-sided spool positioned within the internal volume between the inlet insert and the spool cap, the dual-sided spool including:
a first side defining a first flow channel with a first flow path and a second flow path that diverges from the first flow path at a first end of the second flow path, and that directs fluid from the second flow path into the first flow path at a second end of the second flow path in a flow direction opposed to fluid flow in the first flow path, to generate turbulence within the first flow path to reduce a magnitude of pressure spikes in fluid flowing from the inlet opening to the outlet opening; and
a second side defining a second flow channel in communication with the first flow channel.

17. The pressure reduction assembly of claim 16, wherein the second flow channel includes a third flow path and a fourth flow path that diverges from the third flow path at a first end and rejoins the third flow path at a second end in a direction opposed to fluid flow in the third flow path to generate additional turbulence.

18. The pressure reduction assembly of claim 16, wherein the dual-sided spool includes an internal flow passage that extends between the first side and the second side to direct flow from the first flow channel to the second flow channel.

19. The pressure reduction assembly of claim 16, wherein the second flow path is included in a plurality of second flow paths arranged successively along the first flow path to successively divert flow from the first flow path and return the diverted flow to the first flow path to generate turbulence.

20. The pressure reduction assembly of claim 16, wherein the second flow channel has a different flow geometry than the first flow channel.
